(19) United States
(12) Patent Application Publication
(10) Pub. No.: US 2003/0095657 A1
(43) Pub. Date: May 22, 2003

(54) Adhesive arrangement for a mobile communications apparatus

(75) Inventor: Mikko Laaksonen, Angelniemi (FI)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/295,317

(22) Filed: Nov. 15, 2002

(30) Foreign Application Priority Data
Nov. 16, 2001 (FI) 20012229

(51) Int. Cl. H04M 1/00; H04M 9/00

(52) U.S. Cl. 379/419; 379/428.01

(57) ABSTRACT

The invention relates to an adhesive assembly to be used in a portable electronic apparatus, such as a mobile telephone. A window panel of the apparatus is secured on the apparatus with the assembly. The assembly comprises a mainly planar base element and an adhesive layer on the surface of the base element. An acoustic element, made of material that allows the penetration of acoustic waves, is integrated with the base element.

### FIELD OF THE INVENTION

The invention relates to an adhesive assembly and a method of producing such an assembly, a mobile telephone, a mobile telephone cover and a mobile communications apparatus. In particular, the invention relates to a novel and inventive way of mounting a window panel of a mobile communications or telecommunications apparatus firmly on the apparatus in order to attain waterproof and dustproof structure.

### PRIOR ART

A mobile communications or telecommunications apparatus, such as a mobile telephone, usually comprises a display and a loudspeaker. Typically, such an apparatus has a cover made of more than one piece, inside which cover the electronic equipment of the apparatus is arranged. The cover, typically the part of it called in this text the front cover, has an opening for permitting the display to be seen from outside the apparatus. This window opening is typically covered with a window panel, usually a thin piece of at least partly transparent plastics. The window panel is normally glued or welded either on the inside or the outside of the front cover. The glue is typically arranged in the form of a mainly planar adhesive element, comprising an elastic base of e.g. foam like material on which adhesive is laminated. Through the adhesive element an opening is formed to be arranged on the display.

It is sometimes convenient, e.g. if the loudspeaker of the apparatus is arranged near the display to arrange the acoustic opening or openings of the loudspeaker on the window panel. Such is the case e.g. with some of the modern mobile telephones. Typically in this case the acoustic opening or openings have to be arranged through the adhesive element, too. The acoustic opening or openings have to be covered with some sort of a shield in order to prohibit water, dust or other kind of unwanted materials from getting in contact with the inside of the apparatus. Known solutions suggest e.g. that a separate piece of fabric, net or mesh is arranged between the adhesive element and the front cover or between the adhesive element and the window panel. Where a window panel is arranged inside the front cover it is known to arrange a separate piece of net or mesh on the backside of that window panel.

There are a number of disadvantages in the prior art solutions. Some materials are not at all suitable to be welded together. Assembling a separate piece of fabric, net or mesh requires its own stage of operation on the assembly line of the apparatus. Furthermore, the separate part needs its own transportation and storage capacity. It is difficult to accomplish reliably leak-proof joints between the separate piece of fabric, net or mesh and the cover and the window panel. Normal use of e.g. a mobile telephone causes such bending and distortion to the structure of the apparatus that may cause loosening of the separate parts. Also changes in temperature conditions cause leaks in the prior art solutions. The separate piece of fabric, net or mesh takes its part of the often so valuable space inside the apparatus.

The object of the present invention is to achieve an adhesive assembly and a method of producing such an assembly, a mobile telephone, a mobile telephone cover and a mobile communications apparatus whereby the above described drawbacks of the prior art can be minimized.

The object of the present invention is especially to achieve a mobile communications or telecommunications apparatus, such as a mobile telephone, which is easy and economic to produce. A further object of the present invention is a reliable and at least substantially watertight and/or dustproof window arrangement on a mobile telecommunications apparatus.

### SUMMARY OF THE INVENTION AND SOME OF ITS PREFERRED EMBODIMENTS

A typical adhesive assembly according to the invention is to be used in a portable electronic apparatus. A window panel of the apparatus is securely mounted on the apparatus with the assembly. A typical assembly comprises at least

a mainly planar base element comprising a first surface and a second surface, and

an adhesive layer on at least one surface of the base element.

The base element is typically formed of an elastic and e.g. foam-like material on which the adhesive layer is laminated. Although the base element is typically mainly planar the adhesive assembly can e.g. have parts protruding away from the window panel, which parts need not to be on the same plane with the inventive part of the base element. At least one acoustic means is arranged on that part of the adhesive assembly that is meant to be situated on or under the acoustic opening or openings of the loudspeaker of the portable electronic apparatus. The acoustic means, such as an opening, reaches through the base element and the at least one adhesive layer in order to allow easy penetration of acoustic waves through the assembly. In a typical adhesive assembly according to the invention an acoustic element, e.g. a piece of suitable acoustic fabric, net or mesh is integrated with the base element. Typical acoustic element is made of material that allows an easy penetration of acoustic waves.

A typical mobile communications or telecommunications apparatus, a typical mobile telephone or a typical mobile telephone cover according to the invention comprises an adhesive assembly according to the invention. Mobile communications apparatus could be e.g. a PDA i.e. a personal digital assistant.

A typical method according to the invention of producing an adhesive assembly for portable electronic apparatus from a mainly planar base element comprising a first surface and a second surface, comprises at least the following steps:

forming at least one opening on the base element,

mounting an acoustic element on said opening,

covering at least a part of the acoustic element with a hindering element,

laminating at least one surface of the base element with an adhesive layer in such a way that the adhesive layer covers at least substantially said surface of the base element,

removing the hindering element.

By the hindering element it is meant any suitable means that prohibits the acoustic element from getting fully covered by the adhesive, e.g. a piece of paper or plastics that can be stripped off after the application of the adhesive layer.

One of the most important advantages of the invention is that the assembly of a portable electronic apparatus becomes more simple and economic due to the fact that the invention takes away one part from the apparatus and thus one step from assembly process.

Another important advantage of the invention is that by using the adhesive assembly in question it is easy to produce apparatuses that are watertight and/or resistant to other non-wanted materials, such as dust. The above-mentioned watertightness and resistivity of the electronic apparatus is implemented more reliably than by the known present solutions.

An advantageous adhesive assembly according to the present invention is formed as one fixed body, i.e. the acoustic element is non-detachable from the base element. The acoustic element could also be arranged detachable from the base element but the solution with one fixed body enhances the advantages of the invention, e.g. the easier assembly.

An advantageous embodiment of the adhesive assembly according to the present invention comprises an adhesive layer on the first and the second surface of the base element. The adhesive layer on both surfaces allows the securing of the window panel on the front cover of the apparatus without any additional adhesive or glue.

An advantageous embodiment of the adhesive assembly according to the present invention has its acoustic element partly covered by the adhesive layer. In another advantageous embodiment the adhesive layer covers the joint between the base element and the acoustic element. These solutions make said joint and thus the inventive assembly more reliable and resistant against any leaks, e.g. water. The adhesive layer on said joint or on the acoustic element secures the acoustic element firmly on the base element. If the adhesive layer is present on both sides of the adhesive assembly the aforesaid advantages are further emphasized.

An advantageous embodiment of the adhesive assembly according to the present invention has a window opening formed through the assembly to allow that the display of the apparatus is visible through the assembly. The opening is needed, because the base element is usually made of non-transparent material. Advantageously the adhesive assembly surrounds the edges of the window panel as a narrow strip, thus providing a secure fixation and some elasticity to the joint between the window panel and the cover of the apparatus. The elasticity is important in damping the bending and distortion of the structure caused by normal use of e.g. a mobile telephone.

A further advantageous embodiment of the adhesive assembly according to the present invention has the acoustic element formed of a material that is at least substantially watertight at normal pressure conditions. This ensures the watertightness of the innovative assembly in normal use. Typical materials to be used for the acoustic element are Gore-Tex™ and similar materials.

When arranging the adhesive layer on the base element according to the method of the invention it is most advantageous to cover the joint between the base element and the acoustic element and at least part of the hindering element with the adhesive layer before removing the hindering element. This ensures a firm and leakproof fixation of the acoustic element on the base element. This especially improves the waterproofness of the adhesive assembly according to the question.

### A BRIEF DESCRIPTION OF THE DRAWINGS

The invention shall be described in more detail below with reference to the appended schematical drawings, wherein

FIG. 1 is a perspective view of an adhesive assembly according to the invention,

FIG. 2 is a cross-sectional view of a first adhesive assembly according to the invention,

FIG. 3 is a cross-sectional view of a second adhesive assembly according to the invention, and

FIG. 4 illustrates a perspective view of an adhesive assembly, a window panel and a front cover of a mobile telephone according to the invention.

### A DETAILED DESCRIPTION OF PREFERRED EMBODIMENTS

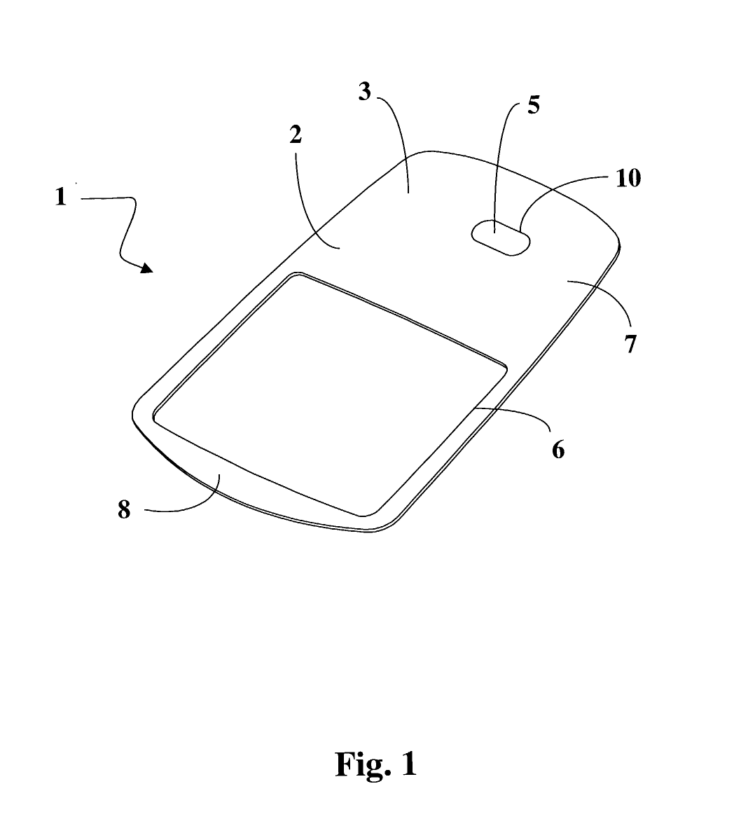

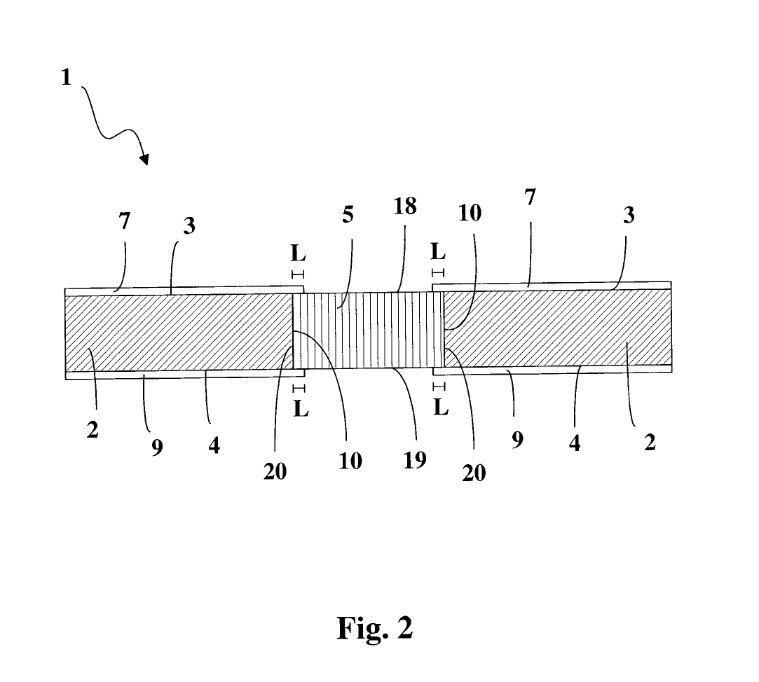

FIG. 1 illustrates a typical adhesive assembly 1 for a mobile telephone according to the invention. The assembly comprises a mainly planar base element 2 with a visible first surface 3 and a second surface 4, best seen in FIG. 2. An acoustic element 5 is integrated in the base element 2. A window opening 6 is formed in the assembly 1. The first surface 3 is laminated with a thin first layer 7 of adhesive material, which layer 7 is best seen on FIG. 2. The part 8 of the assembly surrounding the window opening 6 is formed as a thin strip. The form of the assembly 1 can vary according to the needs of apparatus it is meant for.

In the cross-sectional view of FIG. 2 it is schematically illustrated how the acoustic element 5 is integrated in the base element 2. The adhesive layer 7 on the first surface 3 of the base element and the adhesive layer 9 on the second surface 4 of the base element cover the joint 10 between the base element 2 and the acoustic element 5 and a short distance L of the acoustic element 5, too. The acoustic element 5 has a first surface 18 and a second surface 19. Reference number 20 shows the edges of the opening formed through the adhesive assembly 1.

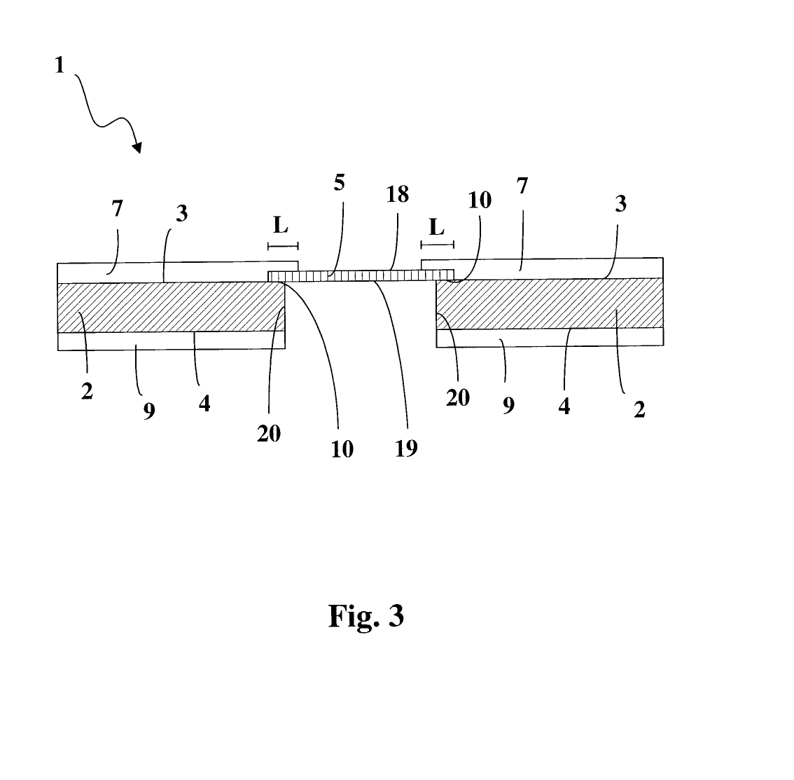

The same reference numbers are used in FIGS. 2 and 3 for corresponding details. In the example of FIG. 3 the acoustic element 5 is not arranged on the inside of the opening 20, as in FIG. 2, but the element 5 is arranged on the first surface 3 of the base element 2 in such a way that it covers the opening 20. As in FIG. 2, the adhesive layer 7 on the first side 3 covers the joint 10 between the base element 2 and the acoustic element 5 and a short distance L of the acoustic element 5, too.

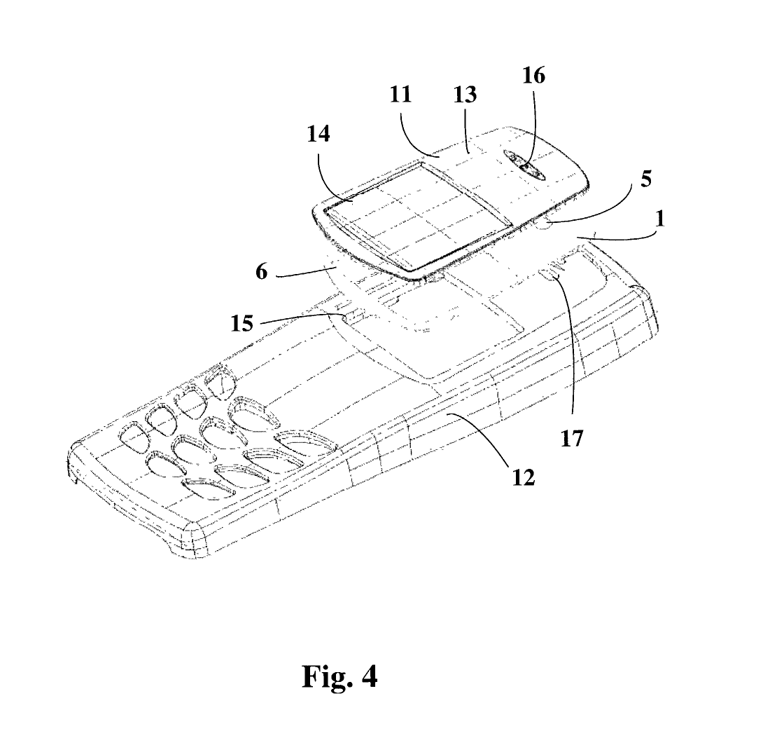

FIG. 4 illustrates one possible embodiment where an adhesive element 1 according to the invention is situated between the window panel 11 and the cover 12 of a mobile telephone. The panel 11 and the element 1 are of approximately the same size. The window panel 11 comprises a frame 13 and a window 14. The window opening 6 of the adhesive assembly 1 is approximately of the same size with the actual window 14. A recess 15 is formed on the cover 12 to receive the panel 11 and adhesive element 1. Acoustic openings 16 and 17 are formed on the window panel 11 and on the cover 12 respectively.

The base element 2 and the one or more adhesive layers 7, 9 covering the base element are typically made of materials that have good sound insulation properties. Therefore, some sort of an acoustic means is needed to ease the penetration of acoustic waves from the loudspeaker (not shown) inside the telephone through the cover 12, adhesive element 1 and the window panel 11. According to the invention the adhesive assembly 1 comprises the integrated acoustic element 5, which is to be situated between the openings 16 and 17 to prevent water and dust from getting in the phone.

According to one possible manufacturing method for the adhesive elements 1 in FIGS. 2 and 3, an opening 20 is first formed through the mainly planar base element 2. The acoustic element 5 is then mounted on said opening 20. In the assembly 1 of FIG. 2 the acoustic element 5 is arranged on the inside of the opening 20. In the assembly 1 of FIG. 3 the acoustic element 5 is arranged on one side of the opening 20, i.e. on the side of the first surface 3. A part of the acoustic element 5 is then covered with a hindering element (not shown). In the example of FIG. 2 the hindering element is arranged on both surfaces 18 and 19 of the acoustic element 5. In the example of FIG. 3 the hindering element is arranged on the first surface 18 and the other side of the assembly 1 the hindering element can be arranged for example only on the second surface 19 of the acoustic element 5 or to fill the whole space defined by the surface 19 and the edges of the opening 20. Thereafter both surfaces 3 and 4 as well as the hindering element are laminated with adhesive layers 7 and 9. Now the hindering element is removed and a region without an adhesive layer is created on both surfaces 18 and 19 of the acoustic element 5.

For a man skilled in the art, it is obvious that the invention is not restricted to the above-described examples only, but it may vary within scope of the claims set forth below. E.g. in the examples above the window panel 11 is situated outside the cover 12. With the adhesive assembly of the invention the window could also be fixed on the inside of the cover. The window panel does not need to have a frame around the actual window. Some adhesive could be used between the acoustic element and the base element. The invention can be used in many kinds of portable electronic apparatuses, e.g. a portable computer, a measuring device or a GPS receiver. The acoustic element can vary in size and there can be more than one acoustic element in an adhesive assembly according to the invention. The adhesive assembly and its acoustic element according to the invention can also be used to cover the microphone of a portable electronic apparatus and it is possible to secure other cover parts than a window cover with an assembly similar to the one described in this application.

1. An adhesive assembly for portable electronic apparatus for securely mounting a window panel of the apparatus on the apparatus, which assembly comprises
a mainly planar base element comprising a first surface and a second surface,
an adhesive layer on at least one surface of the base element,
through which base element and adhesive layer at least one acoustic means is arranged for facilitating the penetration of acoustic waves through the assembly, the acoustic means comprising an acoustic element made of material that allows easy penetration of acoustic waves.

2. An assembly according to claim 1, wherein the assembly is formed as one fixed body.

3. An assembly according to claim 1, which assembly comprises an adhesive layer on both the first and the second surface of the base element.

4. An assembly according to claim 1, wherein the adhesive layer is arranged to cover the joint between the base element and the acoustic element.

5. An assembly according to claim 4, wherein the adhesive layer is arranged to cover at least a part of the acoustic element.

6. An assembly according to claim 1, wherein a window opening is formed through the assembly to allow visibility of the display of the apparatus through the assembly.

7. An assembly according to claim 1, wherein the acoustic element is formed of a material that is at least substantially watertight at normal operating pressure of the apparatus.

8. A mobile telephone comprising an adhesive assembly for securely mounting a window panel of the telephone on the telephone, which assembly comprises
a mainly planar base element comprising a first surface and a second surface,
an adhesive layer on at least one surface of the base element,
through which base element and adhesive layer at least one acoustic means is arranged for facilitating the penetration of acoustic waves through the assembly, the acoustic means comprising an acoustic element made of material that allows easy penetration of acoustic waves.

9. A mobile communications apparatus comprising an adhesive assembly for securely mounting a window panel of the mobile communications apparatus on the apparatus, which assembly comprises
a mainly planar base element comprising a first surface and a second surface,
an adhesive layer on at least one surface of the base element,
through which base element and adhesive layer at least one acoustic means is arranged for facilitating the penetration of acoustic waves through the assembly, the acoustic means comprising an acoustic element made of material that allows easy penetration of acoustic waves.

10. A mobile telephone cover comprising an adhesive assembly for securely mounting a window panel of the mobile communications apparatus on the apparatus, which assembly comprises
a mainly planar base element comprising a first surface and a second surface,
an adhesive layer on at least one surface of the base element,
through which base element and adhesive layer at least one acoustic means is arranged for facilitating the penetration of acoustic waves through the assembly, the acoustic means comprising an acoustic element made of material that allows easy penetration of acoustic waves.

11. A method of producing an adhesive assembly for portable electronic apparatus, such as a mobile telephone, from a mainly planar base element comprising a first surface and a second surface, the method comprising the steps of
forming at least one opening through the base element,
mounting an acoustic element on said opening,
covering at least a part of the acoustic element with a hindering element,
laminating at least one surface of the base element with an adhesive layer in such a way that the adhesive layer covers at least substantially said surface of the base element,
removing the hindering element.

12. A method according to claim 11, wherein before removing the hindering element the joint between the base element and the acoustic element and at least part of the hindering element are covered with the adhesive layer.
